(19) United States
(12) Patent Application Publication
(10) Pub. No.: US 2014/0105581 A1
(43) Pub. Date: Apr. 17, 2014

(54) INFORMATION PROCESSING APPARATUS AND INFORMATION PROCESSING METHOD

(71) Applicant: Sony Corporation, Tokyo (JP)

(72) Inventors: Tetsuya Makabe, Kanagawa (JP); Taku Aida, Kanagawa (JP); Takashi Furukawa, Kanagawa (JP); Shigeki Toyoda, Kanagawa (JP)

(73) Assignee: Sony Corporation, Tokyo (JP)

(21) Appl. No.: 14/047,754

(22) Filed: Oct. 7, 2013

(30) Foreign Application Priority Data
Oct. 12, 2012 (JP) 2012-227355

(51) Int. Cl. G11B 27/031

(52) U.S. Cl. CPC G11B 27/031
USPC 386/288

(57) ABSTRACT

An information processing apparatus includes a recording unit and a control unit. The recording unit is capable of performing random access to a recording medium by a data block corresponding to a predetermined reproduction time period. The control unit is configured to cause, when partial data blocks in a plurality of data blocks which are recorded as a first file in the recording medium are edited, the recording unit to record the edited data blocks in a free space of the recording medium as a second file.

### CROSS REFERENCE TO RELATED APPLICATIONS

This application claims the benefit of Japanese Priority Patent Application JP 2012-227355 filed Oct. 12, 2012, the entire contents of which are incorporated herein by reference.

### BACKGROUND

The present disclosure relates to an information processing apparatus and an information processing method for editing video data and audio data recorded in a recording medium, for example.

In a broadcast station or the like, a desired section of video data and audio data obtained by performing image taking by an image-pickup apparatus and recorded in a recording medium may be sometimes edited. An edited section is connected with preceding and subsequent sections thereof logically on a file system, thereby providing one continuous piece of data. This editing is called as “insert and assemble editing”, “linear editing”, or the like. Hereinafter, the editing is referred to as “linear editing”. In the linear editing, data prior to editing is called as “primary data”, and data after editing is called as “edit data”.

As a technology relating to the linear editing, Japanese Patent Application Laid-open No. 2011-28800 discloses that, to suppress a reduction of access speed due to an occurrence of fragmentation depending on a file system, when a part of primary data is deleted by editing, a recording and reproduction apparatus stores information that specifies a physical area in which the deleted part of the primary data is recorded as a reservation area for each recording unit. Then, in the case where edit data is input in accordance with an instruction to start editing, the recording and reproduction apparatus overwrites the edit data in the reservation area preferentially. As a result, the edit data is recorded in the area from which the primary data is deleted, thereby preventing dispersion of data storage area.

### SUMMARY

However, in a system that performs the linear editing, various improvements are demanded in terms of the linear editing in unit of variable-length data block, a countermeasure for the case where a logical structure of data which is being edited is collapsed due to power shutdown during the editing, or the like.

In view of the above-mentioned circumstances, it is desirable to provide an information processing apparatus and an information processing method capable of achieving the high functionality and improvement of the linear editing.

According to an embodiment of the present disclosure, there is provided an information processing apparatus including a recording unit and a control unit. The recording unit is capable of performing random access to a recording medium by a data block corresponding to a predetermined reproduction time period. The control unit is configured to cause, when partial data blocks in a plurality of data blocks which are recorded as a first file in the recording medium are edited, the recording unit to record the edited data blocks in a free space of the recording medium as a second file.

The control unit may update, when an instruction to determine an edit is given, management information of a file system to logically replace the data blocks that constitute the second file by the partial data blocks in the first file.

The information processing apparatus according to the embodiment may further include a memory. The control unit may cause the memory to hold information relating to a recorded position of at least the second file in the recording medium until the instruction to determine the edit is given.

The control unit may perform control, when an instruction to perform a review operation is given, to read and reproduce the edited data blocks from the recording medium by using the information held in the memory.

Further, in the information processing apparatus, the data blocks can be variable-length data blocks.

Furthermore, the data blocks can include video data and audio data in the predetermined reproduction time period.

According to another embodiment of the present disclosure, there is provided an information processing method including preparing a recording unit capable of performing random access to a recording medium by a data block corresponding to a predetermined reproduction time period, and causing, when partial data blocks in a plurality of data blocks which are recorded as a first file in the recording medium are edited, the recording unit to record the edited data blocks in a free space of the recording medium as a second file by a control unit.

As described above, according to the embodiments of the present disclosure, it is possible to achieve the higher functionality and improvement of the linear editing.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a block diagram showing a video and audio recording apparatus serving as an information processing apparatus according to a first embodiment of the present disclosure;

FIG. 2 is a diagram showing a structural example of primary data in unit of a clip;

FIG. 3 is a diagram showing a typical method in the case where linear editing is performed for partial video data included in a primary clip;

FIG. 4 is a flowchart relating to a linear editing operation in the embodiment;

FIG. 5 is a diagram showing an operation of generating a temporary clip in the linear editing operation in the embodiment;

FIG. 6 is a diagram showing an operation of inserting a data block of the temporary clip in a deleted area of the primary clip in the linear editing operation in the embodiment;

FIG. 7 is a diagram showing an relationship between time and an access of a recording medium in a review operation and in the linear editing operation of a linear editing system with a tape as the recording medium; and

FIG. 8 is a diagram showing a relationship between time and an access of a recording medium in the review operation and in the linear editing operation in the case where the video and audio recording apparatus of this embodiment is used for the linear editing system.

### DETAILED DESCRIPTION OF EMBODIMENTS

Hereinafter, an embodiment of the present disclosure will be described with reference to the drawings.

### First Embodiment

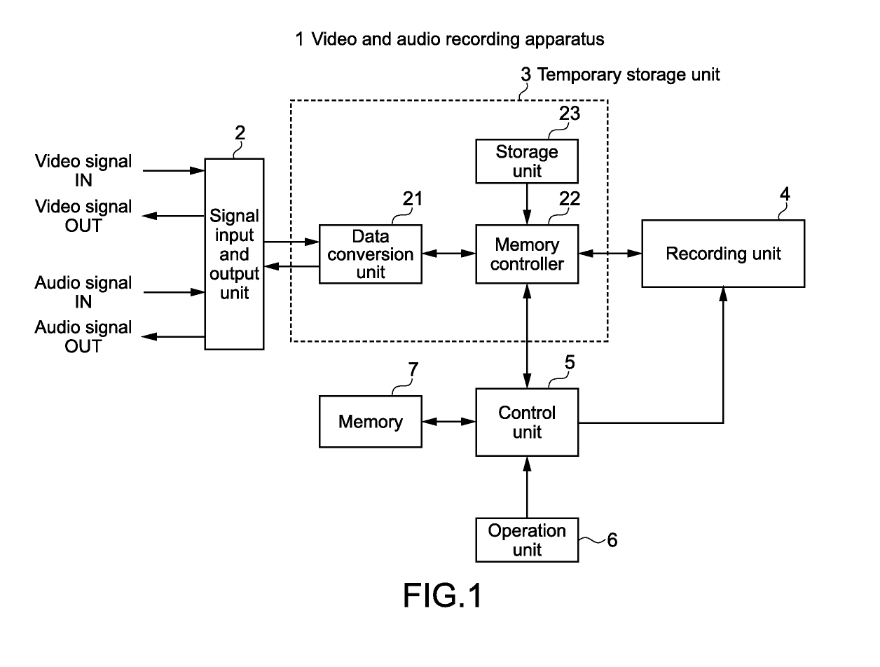

FIG. 1 is a block diagram showing a video and audio recording apparatus 1 serving as an information processing apparatus according to a first embodiment of the present disclosure.

The video and audio recording apparatus 1 is provided with a signal input and output unit 2, a temporary storage unit 3, a recording unit 4, a control unit 5, an operation unit 6, and a memory 7.

The signal input and output unit 2 inputs a video signal and an audio signal from an external apparatus such as an image pickup apparatus (not shown) or the like, codes the input video signal, or generates attendant data such as proxy AV data and metadata, for example. The signal input and output unit 2 supplies the coded video data and audio data and the attendant data generated to the temporary storage unit 3. Here, the proxy AV data refers to video data and audio data at a low resolution. An example of the metadata is clip metadata. The clip metadata is metadata for providing a title, a comment, and the like for each clip.

Further, the signal input and output unit 2 can decode the video data output from the temporary storage unit 3 to output the decoded data to an external apparatus such as an image pickup apparatus and a monitor or output the audio data or the like output from the temporary storage unit 3 to the external apparatus, for example. Furthermore, the signal input and output unit 2 can decode the proxy AV data output from the temporary storage unit 3 to supply the decoded data to the external apparatus.

The temporary storage unit 3 is provided with a data conversion unit 21 for performing data compression and decompression, a storage unit 23 for temporarily storing the data, and a memory controller 22 for controlling a data volume or the like of the data to be stored in the storage unit 23.

The memory controller 22 stores record data from the data conversion unit 21 in the storage unit 23 and reads the record data from the storage unit 23 to supply the data to the recording unit. The memory controller 22 stores the data reproduced from the recording unit in the storage unit 23, reads the reproduction data from the storage unit 23, and supplies the data to the data conversion unit 21.

The data conversion unit 21 divides the video data, the audio data, the attendant data, and the like supplied from the signal input and output unit 2 for each piece of data by a predetermined reproduction time period, compresses those pieces of data, generates data for recording, and supplies the data to the memory controller 22. As a compression method, for example, MPEG (moving picture experts group), JPEG (joint photographic experts group), or the like can be used.

In addition, the data conversion unit 21 decompresses the reproduction data supplied from the memory controller 22 and supplies the data to the signal input and output unit 2.

The recording unit 4 records the video data, the audio data, and the attendant data to a predetermined recording medium. The recording unit 4 generates variable-length data blocks from the video data, the audio data, and the attendant data by the predetermined reproduction time period which are supplied from the temporary storage unit 3 and records the data blocks in the recording medium. The recording unit 4 is a random-accessible storage such as an SSD (solid state drive) and an HDD (hard disk drive) specifically. The data blocks recorded in the recording medium are managed by a predetermined file system. The file system manages physical positional information of the data blocks stored in the file and manages management information that logically associates the data blocks.

The control unit 5 controls recording and reading of primary data, recording of edit data, and the like with respect to the recording unit 4. The control unit 5 performs an operation process for editing the primary data read from the recording medium by the recording unit 4.

It should be noted that the video data and audio data prior to the editing are referred to as the “primary data” and the video data and audio data after the editing are referred to as the “edit data”.

The operation unit 6 receives an instruction of a process to be executed by the control unit 5 from a user and outputs the instruction to the control unit 5.

(Structure of Primary Data)

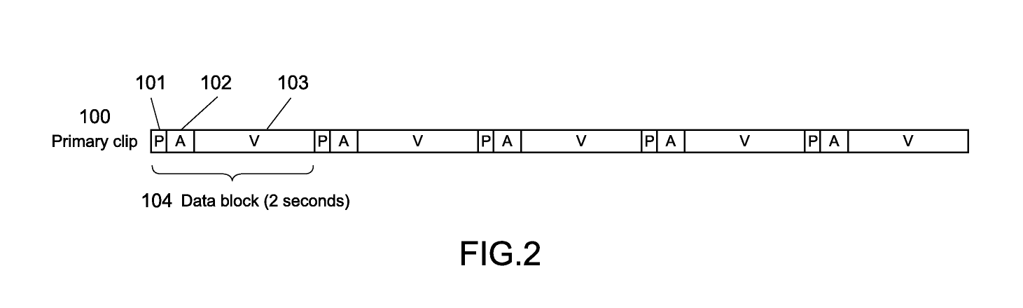

FIG. 2 is a diagram showing the structure of the primary data 100 on a clip-by-clip basis (hereinafter, referred to as “primary clip”).

The “clip” is a set of pieces of data as a unit of reproduction that actual-time reproduction is to be ensured, for example, a set of pieces of data from a start of image taking until an end thereof by an image pickup apparatus. The clip is constituted of one or more files managed by the file system.

The primary clip 100 is constituted of one or more data blocks 104. One data block 104 is constituted of an attendant data field 101, an audio field 102, and a video field 103. In this example, in the case where the video data has a transfer rate of 50 Mbps, and the audio data is a format of 24 bits/8 channels, a data volume stored in the one data block 104 is 15.8 Mbytes. The audio data and the video data included in the one data block 104 correspond to a reproduction time period of approximately 2 seconds.

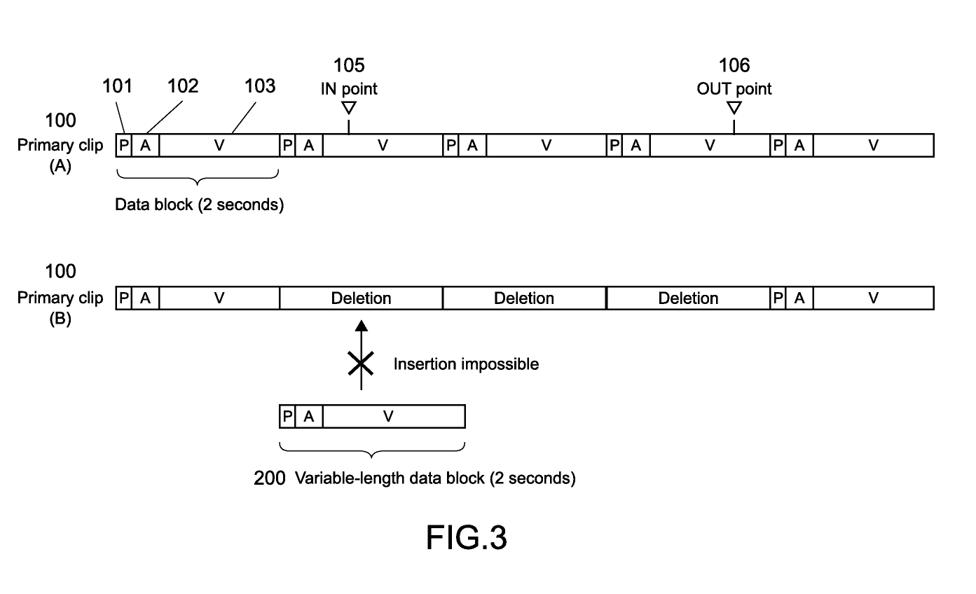

FIG. 3 is a diagram showing a typical method in the case where the linear editing is performed for part of the video data included in the primary clip 100 shown in FIG. 2. Here, the case where, in the primary clip (A) 100, an area from an IN point 105 to an OUT point 106 in the video field 103 is specified as an edit target of the primary data is considered. In a typical linear editing, data blocks including an area from the IN point 105 to the OUT point 106 are logically deleted in the primary clip (B) 100, and edit data is physically inserted (overwritten) in the deleted area. However, because the typical linear editing method is a method of physically inserting the edit data in the deleted area, the data blocks are limited to have fixed lengths. In other words, it is difficult to apply the method to the case where the data blocks are variable-length data blocks coded by a variable-length coding method in which the amount of generated codes are increased or decreased depending on a design or image quality.

In view of this, the video and audio recording apparatus 1 in this embodiment records one or more data blocks including the edit data in a different area (free space) other than the primary clip as a different file. When receiving an instruction to determine the linear editing from the user, the video and audio recording apparatus 1 logically deletes the data blocks including the primary data to be edited in the primary clip and updates the management information of the file system so as to logically replace the blocks by data blocks including the edit data.

In the following, an operation of the linear editing according to this embodiment will be described in detail.

(Details of Linear Editing Operation)

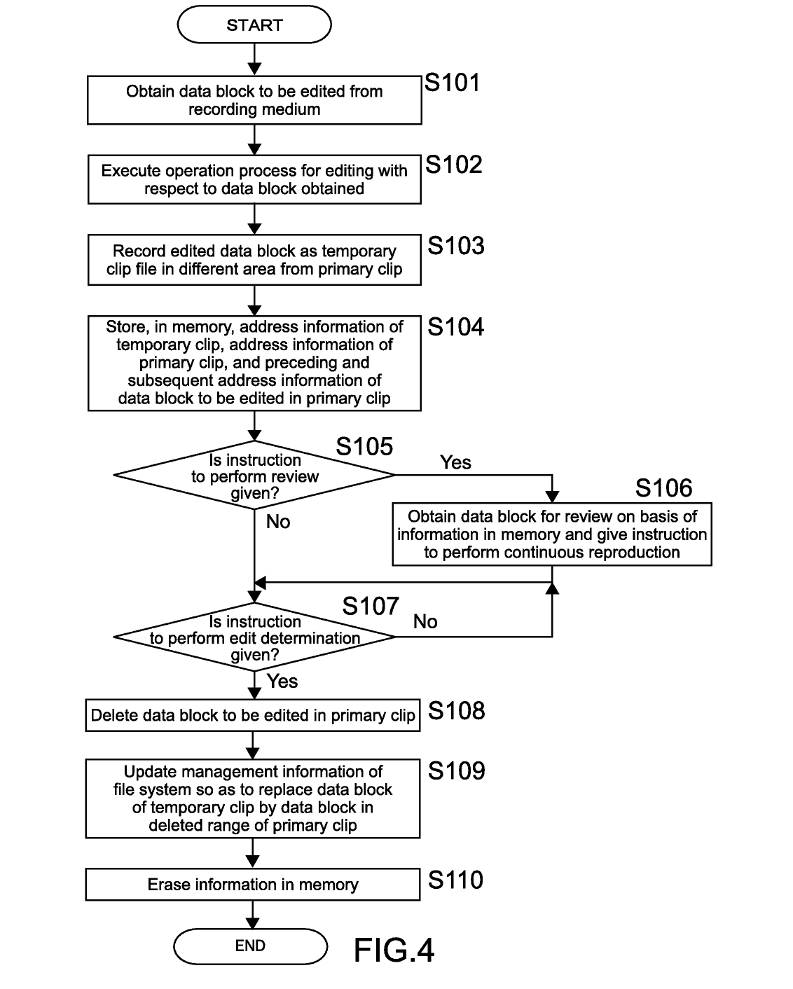

FIG. 4 is a flowchart relating to the linear editing operation according to this embodiment.

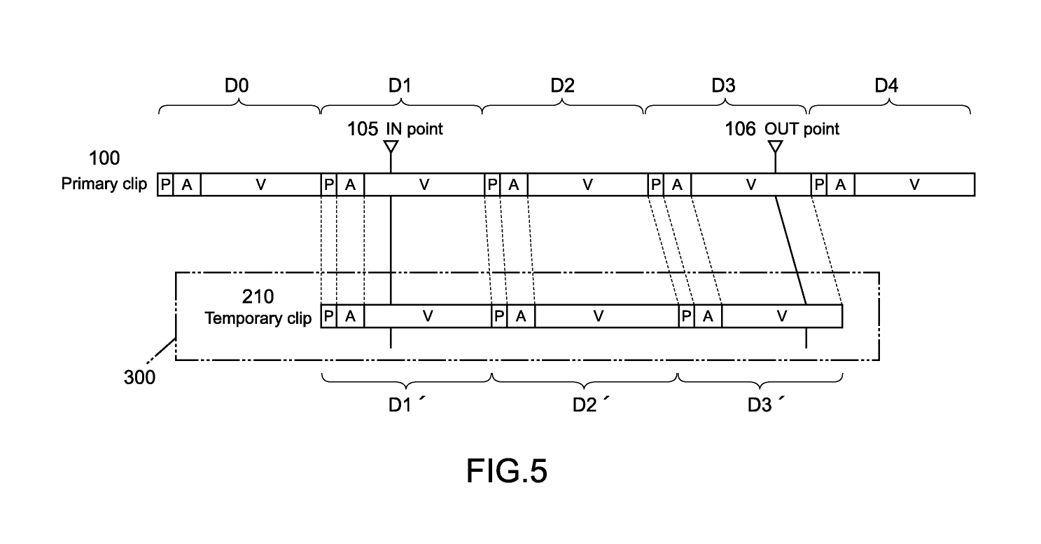

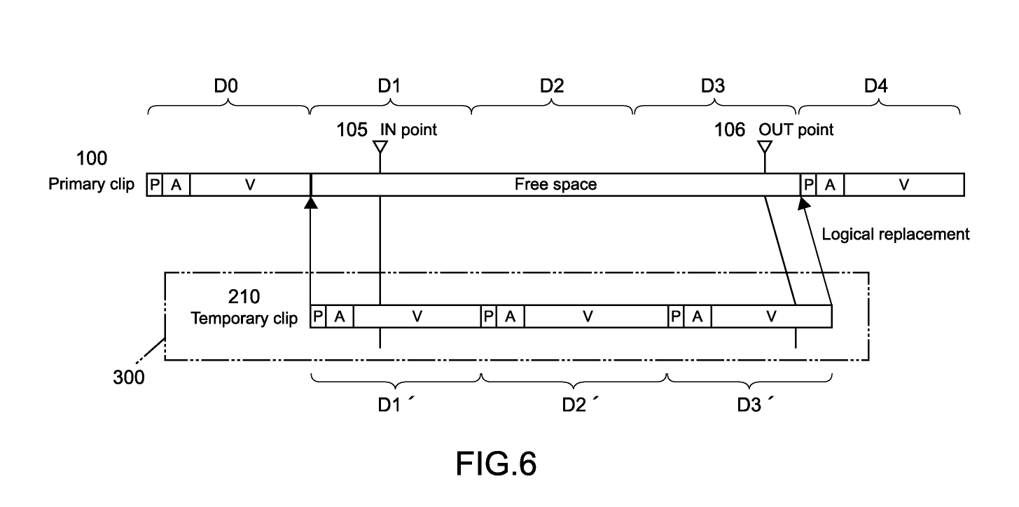

FIGS. 5 and 6 are schematic diagrams each showing the linear editing operation according to this embodiment.

In the figures, the case where the operation unit 6 specifies video data in a section from the IN point 105 to the OUT point 106 as an edit target in the video field 103 is considered.

The control unit 5 gives an instruction to the recording unit 4 to read data blocks (D1, D2, and D3) including the video data in the section from the IN point 105 to the OUT point 106 as data blocks to be edited and obtains the data blocks to be edited (Step S101).

The control unit 5 performs an operation process for the editing specified by the user for the video data of the data blocks D1, D2, and D3 read from the recording medium by the recording unit 4 (Step S102) and gives an instruction to the recording unit 4 to record data blocks (D1′, D2′, and D3′) including the edit data as a file of a temporary clip 210 in a different area 300 (free space) from the primary clip 100 (Step S103).

The operations described above are also performed in the case where the edit target is the audio data.

In this way, by recording the data blocks (D1′, D2′, and D3′) including the edit data in the different area (free space) from the primary clip 100, it is possible to deal with the linear editing of the variable-length data blocks.

The control unit 5 stores information necessary for accessing the data blocks of the entire clip including the edit data in the memory (Step S104). The information includes address information of the temporary clip 210, address information of the primary clip 100, address information of preceding and subsequent ones of the data blocks to be edited in the primary clip 100, or the like. Those pieces of address information are stored in the memory 7 until an instruction of edit determination is given to the control unit 5 by the user.

After that, the user can give an instruction to the control unit 5 to perform a review operation for an edit result or determine the edit.

In the case where the instruction to perform the review operation is given to the control unit 5 by the user (YES in Step S105), on the basis of the information held in the memory 7, the control unit 5 instructs the recording unit 4 and the temporary storage unit 3 to continuously reproduce a range from a head of the primary clip 100 up to a data block (D0) immediately before the data blocks (D1, D2, and D3) to be edited, the temporary clip 210, and a range from a data block (D4) immediately after the data blocks (D1, D2, and D3) to be edited of the primary clip 100 up to an end of the primary clip 100. As a result, before the edit is determined, it is possible to review the edit result.

Further, in the case where the instruction to perform the edit determination is given to the control unit 5 by the user (YES in Step S107), as shown in FIG. 6, the data blocks (D1, D2, and D3) including the video data to be edited in the primary clip 100 are logically deleted, that is, deleted on the file system (Step S108).

After that, the control unit 5 updates the management information of the file system so as to insert the data blocks (D1′, D2′, and D3′) that constitute the temporary clip 210 as the data blocks of the range logically deleted in the primary clip 100 (Step S109). The process for updating the management information of the file system is generally called as a “write back process”.

The write back process is performed at a timing when the instruction to perform the edit determination is given to the control unit 5 by the user or at timings as follows.

(1) in the case where a removable medium is used as the recording medium in the recording unit 4, a timing when the removable medium is taken out of the video and audio recording apparatus 1

(2) a timing when the video and audio recording apparatus 1 is brought into a standby state (standby off)

(3) a timing when the power is turned off

After the write back process, the control unit 5 deletes the information stored in the memory 7 (Step S110).

As described above, until the instruction to perform the edit determination is given by the user, the temporary clip 210 exists as a file independent of the primary clip 100. On the other hand, the data blocks (D1, D2, and D3) including the video data to be edited in the primary clip 100 are in the recorded state until the instruction to perform the edit determination is given by the user. Therefore, even if the logical structure of the temporary clip 210 is collapsed due to an occurrence of power shutdown at the time of the linear editing, by performing the same editing for the primary data again, it is possible to regenerate intended edit data.

Further, in this embodiment, the unit of data recorded in the recording medium is not a physical sector of the recording medium but a data block unit of a predetermined reproduction time period. Thus, the probability of spatially dispersed recording of the data blocks including the edit data becomes lower as compared to the case where the edit data of the same size is recorded in a physical sector unit. Therefore, a seek count at the time when the data edited is reproduced is reduced, and the reproduction at a demanded rate is more highly probably achieved.

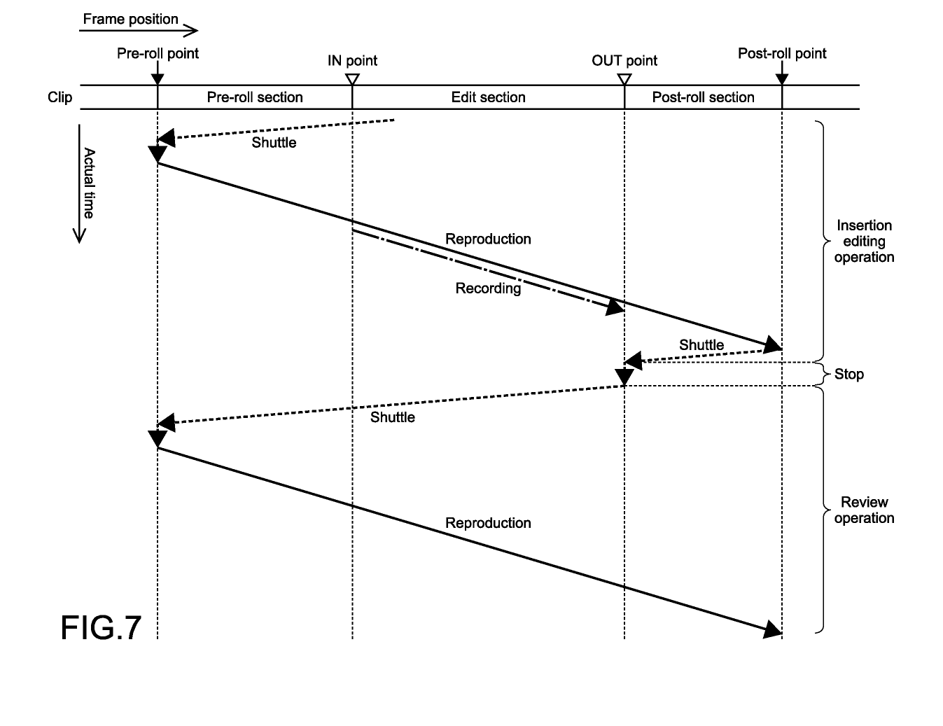

In a linear editing system in which a tape is used as a recording medium, for example, as shown in FIG. 7, real-time editing is performed while performing 1×-speed traveling of the tape. This is because a reproduction head and a recording head are disposed on a drum in a tape recording and reproduction apparatus, and therefore the reproduction and the recording can be performed at the same time along with the 1×-speed traveling of the tape. However, in the case where an HDD, an SSD, or the like is used as the recording medium, data to be edited is reproduced, and then a seek time is generated until it becomes possible to record edit data.

In relation to this, in this embodiment, the unit of data recorded in the recording medium is not the physical sector of the recording medium but the data block unit of the predetermined reproduction time period, which is larger than the physical sector. It should be noted that the size of the physical sector is an order of k (kilo) bytes, while the size of the data block for the reproduction time period of 2 seconds is an order of M (mega) bytes. Therefore, in this embodiment, a seek occurrence frequency is suppressed, and the real-time editing corresponding to the 1×-speed traveling is more highly probably achieved.

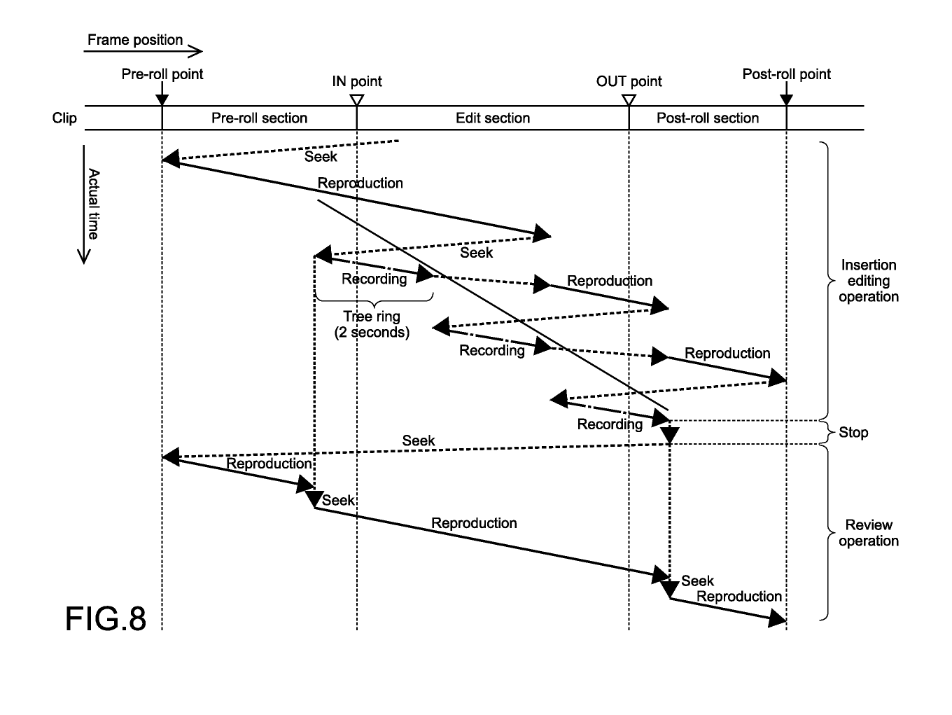

FIG. 8 is a diagram showing a relationship between time and an access of the recording medium in the linear editing operation and the review operation in the case where the linear editing system is used for the video and audio recording apparatus 1 of this embodiment.

This access example shows the case where the reproduction and the recording are switched in the data block unit when the data editing operation is performed. A seek is caused between the recording and the reproduction, and a seek count becomes smaller as the data block size becomes larger. Further, it is possible to perform the recording and the reproduction at a higher speed than 1× speed, so real-time editing by 1×-speed traveling can be sufficiently achieved.

In the review operation after the editing is terminated, seeks are caused before and after the edit section. However, the recording and the reproduction are performed at a higher speed than 1× speed, so the review operation at the 1× speed can be sufficiently achieved even if the seek time is caused.

It should be noted that the present disclosure can take the following configurations.

(1) An information processing apparatus, including:

a recording unit capable of performing random access to a recording medium by a data block corresponding to a predetermined reproduction time period; and

a control unit configured to cause, when partial data blocks in a plurality of data blocks which are recorded as a first file in the recording medium are edited, the recording unit to record the edited data blocks in a free space of the recording medium as a second file.

(2) The information processing apparatus according to Item (1), in which

the control unit updates, when an instruction to determine an edit is given, management information of a file system to logically replace the data blocks that constitute the second file by the partial data blocks in the first file.

(3) The information processing apparatus according to Item (2), further including

a memory, in which

the control unit causes the memory to hold information relating to a recorded position of at least the second file in the recording medium until the instruction to determine the edit is given.

(4) The information processing apparatus according to Item (3), in which

the control unit performs control, when an instruction to perform a review operation is given, to read and reproduce the edited data blocks from the recording medium by using the information held in the memory.

(5) The information processing apparatus according to any one of Items (1) to (4), in which

the data blocks are variable-length data blocks.

(6) The information processing apparatus according to any one of Items (1) to (5), in which

the data blocks include video data and audio data in the predetermined reproduction time period.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a recording unit capable of performing random access to a recording medium by a data block corresponding to a predetermined reproduction time period; and
a control unit configured to cause, when partial data blocks in a plurality of data blocks which are recorded as a first file in the recording medium are edited, the recording unit to record the edited data blocks in a free space of the recording medium as a second file.

2. The information processing apparatus according to claim 1, wherein
the control unit updates, when an instruction to determine an edit is given, management information of a file system to logically replace the data blocks that constitute the second file by the partial data blocks in the first file.

3. The information processing apparatus according to claim 2, further comprising
a memory, wherein
the control unit causes the memory to hold information relating to a recorded position of at least the second file in the recording medium until the instruction to determine the edit is given.

4. The information processing apparatus according to claim 3, wherein
the control unit performs control, when an instruction to perform a review operation is given, to read and reproduce the edited data blocks from the recording medium by using the information held in the memory.

5. The information processing apparatus according to claim 4, wherein
the data blocks are variable-length data blocks.

6. The information processing apparatus according to claim 5, wherein
the data blocks include video data and audio data in the predetermined reproduction time period.

7. An information processing method, comprising:
preparing a recording unit capable of performing random access to a recording medium by a data block corresponding to a predetermined reproduction time period; and
causing, when partial data blocks in a plurality of data blocks which are recorded as a first file in the recording medium are edited, the recording unit to record the edited data blocks in a free space of the recording medium as a second file by a control unit.
